(19) United States
(12) Patent Application Publication
(10) Pub. No.: US 2004/0236869 A1
(43) Pub. Date: Nov. 25, 2004

(54) Parallel information delivery method based on peer-to-peer enabled distributed computing technology and the system thereof

(76) Inventor: Eui Sun Moon, Seoul (KR)

Correspondence Address: BACON & THOMAS, PLLC, 625 SLATERS LANE, FOURTH FLOOR, ALEXANDRIA, VA, 22314

(21) Appl. No.: 10/487,236

(22) PCT Filed: Aug. 26, 2002
(86) PCT No.: PCT/KR02/01600

(30) Foreign Application Priority Data
Aug. 28, 2001 (KR) 2001/52234

(51) Int. Cl. G06F 15/16

(52) U.S. Cl. 709/246; 709/201

(57) ABSTRACT

An information delivery method based on a peer-to-peer enabled distributed computing technology on a network is described. The parallel delivery system and method comprises a server for dividing information to be delivered into data of a predetermined size and storing the divided data; client for requesting arbitrary information; a plurality of peers including Peers for redundantly storing the divided data and performing delivery of the data of the predetermined size on behalf of server. Since information is delivered not through one-to-one delivery between the server and the client but through parallel delivery among a plurality of peers and the client, time required for delivering data of the same size can be remarkable reduced. In addition, since the central server does not centrally control all requests from all clients but the plurality of peers simultaneously process the requests in parallel, load of the server can be greatly reduced.

### TECHNICAL FIELD

The present invention relates to an information delivery method based on a peer-to-peer enabled distributed computing technology on a network More specifically, the present invention relates to an information delivery method, wherein a unit of information (for example, image information such as JPEG or moving picture information such as MPEG) sorted on a file basis or information including plural unit data (for example, web page consisting of plural GIF files) is divided into data smaller than the original information in size and the divided data are then delivered in parallel from a plurality of computers to clients.

### BACKGROUND ART

In general, in order to receive any electronic information through any network, a computer for requesting predetermined information (hereinafter, referred to as a “client”), a computer for providing the information requested by the client (hereinafter, referred to as a “server”), and a network constituting an information delivery path therebetween are required. Since the server and the network are not resources provided to only one client, they may be overloaded due to requests from different clients and such increase of loads may result in a bottleneck phenomenon. As a result, there are problems in that the number of clients capable of simultaneously accessing a server should be limited and a client requesting information could merely use only a part of a bandwidth assigned to itself.

Because of these problems, contents providers who sale information through Internet should make enormous investments, such as purchase of many expensive computers that can serve as servers and have large capacities or expansion of a bandwidth of a network through which information is delivered, in order to increase the number of users and improve service quality. In addition, in order to stably provide information delivery service, the contents providers should predict and prepare the maximum number of clients. However, there are problems in that because it is difficult to accurately predict the number of required clients and the number of required clients also varies with time, if information requests corresponding to the predicted maximum number of clients are not made, it means that resources prepared for the predicted maximum number of clients are wasted, whereas if the prediction goes wrong and the number of clients requesting information is larger than the predicted maximum number of clients, the normal service could not be provided.

In order to solve the aforementioned bottleneck problem occurring in the server and the network, IP multicasting technology has been proposed. This is a technology for reducing load of the server and the network when a plurality of clients simultaneously request the same information such as in live broadcast of moving pictures through Internet. In general, in unicast Internet application programs on TCP/IP, a data transmitter knows an Internet IP address of a receiver, causes the receiver address to be contained in the header of a transmission packet and then transmits the packet In order to make sure that this packet is tranmitted to a correct receiver, many routers on Internet identify the header of the packet and then determine the delivery path. However, a packet for multicast delivery is different in structure. The packet transmitter causes a group address instead of the receiver address to be contained in the header of the packet and delivers the packet. The group address for multicast delivery is D-class IP address (224.0.0.0˜239.255.255.255), which is not an address indicating an specific host, contrary to A-, B- and C-class IP addresses indicating individual Internet hosts all over the world. Therefore, the receiver receiving such multicast packet determines whether he/she belongs to the group of the packet so as to decide whether or not to receive the packet. In order to use such IP multicasting technology over an actual network, a function capable of supporting the IP multicasting is required for the router equipment. However, because only some of current router equipment installed all over the world support the IP multicasting function and it is not likely that all router equipments installed over the present network will be exchanged in the near future, there still has a problem in that great improvement of the network performance by introducing such IP multicasting technology under conditions of current backbone networks cannot be expected in practice.

Another method for solving the bottleneck problem occurring in the server and the network is to use Content Delivery Network (CDN). Since CDN distributes contents through cache servers strategically provided in each network, CDN can provide users with rapid and stable network access environments and also provide Internet businessmen, such as Internet service providers (ISP) or contents providers (CP), with network infastructure for enabling the users to be accepted by means of the distributed computing. The contents are delivered from servers of the contents providers through networks and subscriber lines to the users. During this procedure, speed-down of Internet occurs in the “Middle-Mile”, i.e. a section from the server of the contents provider through networks of NSP or ISP to user-side nodes. It is CDN that solves the problem in the “Middle-Mile.” Since the Internet service Provider (ISP) is sategically provided with the cache servers and the contents are distributed from the server of CP to the cache servers according to CDN, CDN provides the same effect as delivery in the same sub-network, rather than delivery between networks. For this reason, concentration of traffics onto a specific network can be prevented, so that a high delivery rate can be secured. Such CDN technology is implemented by providing several important locations on the network with computers taking the place of the server and causing the computers to process requests on behalf of the server. In such away, load of the server can be reduced and burdens on the network can be reduced by processing requests of clients on the way without running across the network to the server. However, considering that use of such CDN requires preparation costs of a plurality of computers having capacities corresponding to that of the server and that the number of servers performing the CDN function is necessarily limited even though the plurality of computers take the place of the servers, the use of CDN is not a basic solution to the aforementioned problems.

### DISCLOSURE OF INVENTION

The present invention is conceived to solve the problems in the prior art. An object of the present invention is to improve an information delivery rate on a network such as Internet, reduce load occurring in a server and the network and shorten a data delivery path, by enabling information to be delivered in parallel by means of use of a distributed computing technology utilizing idle resources including CPUs and hard discs of general user computers (hereinafter, referred to as “peers”) such as PCs and a bandwidth of the network, and a peer-to-peer technology for enabling data to be delivered between general user computers without passage through the central server.

More specifically, the object of the present invention is to enable clients to make use of rapid delivery, to reduce load in a central server and a network and to shorten a data delivery path by means of delivery of data from adjacent peers rather than the central server, by dividing information to be serviced and redundantly storing the divided data in a plurality of peers on behalf of the central server for entirely storing and delivering the information to be serviced, searching peers storing the divided data corresponding to information requested by the clients and selecting peers capable of providing the most rapid delivery rate when the clients request the information, and causing the data to be delivered in parallel to the clients requesting the information.

In order to accomplish the above objects, a parallel information delivery method on a network according to the present invention comprises the steps of dividing information into data of a predetermined size and storing the data; searching peers capable of providing the data of the predetermined size; selecting at least one peer out of the searched peers in accordance with prescribed rules; receiving the data of the predetermined size in parallel from the selected peer, and restoring the received data of the predetermined size to the information.

Further, in order to accomplish the above objects, a parallel information delivery system on a network according to the present invention comprises a client for requesting information delivery; a server for dividing the information into data of a predetermined size and storing the divided data of the predetermined size; a plurality of peers for storing the divided data of the predetermined size; and at least one agent for managing the data of the predetermined size and/or information on the data stored in the peers and selecting peers suitable for delivering the information out of the plurality of peers in accordance with prescribed rules by analyzing the request of information delivery from the client Moreover, according to another aspect of the present invention, selection of a peer suitable for delivering the information is performed by the client.

### BRIEF DESCRIPTION OF DRAWINGS

FIG. 1 is a conceptual view showing a schematic configuration of a parallel information delivery system on a network according to the present invention.

FIG. 2 is a block diagram showing relationships between actual elements in which the parallel information delivery system on the network according to the present invention is employed.

FIG. 3 is a flowchart illustrating steps of a parallel information delivery method on a network according to one embodiment of the present invention.

### BEST MODE FOR CARRYING OUT THE INVENTION

Features and advantages of the present invention for accomplishing the objects will be more apparent in the following description in conjunction with the accompanying drawings. Hereinafter, embodiments of the present invention will be described in detail with reference to the accompanying drawings.

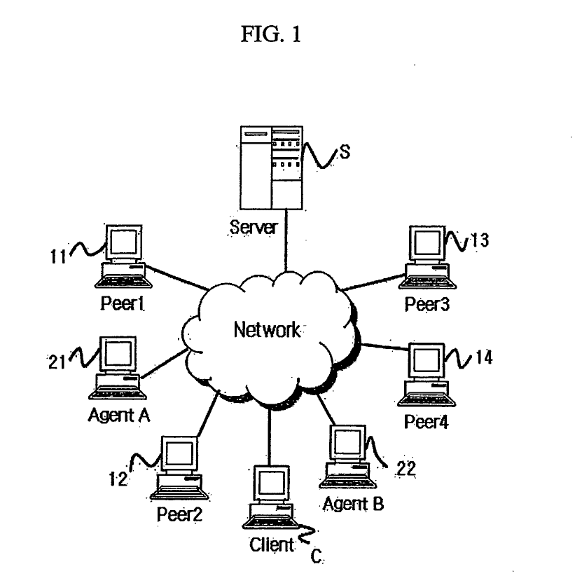

FIG. 1 is a block diagram showing a schematic configuration of a parallel delivery system in which the present invention is employed, comprising the following modules capable of delivering information to one another through an arbitrary network.

The parallel delivery system comprises server S for dividing information to be delivered into data of a predetermined size and storing the divided data; client C for requesting arbitrary information; a plurality of peers including Peers 1, 2, 3 and 4 11, 12, 13 and 14 for performing delivery of the data of the predetermined size on behalf of server S; and at least one agent including Agent A or B 21 or 22 for analyzing the information request from the client and searching peers for delivering the data of the predetermined size on behalf of the server in accordance with the request from the client.

Server S divides information into data of variable or a fixed size(s) and stores the divided data. The divided and stored data can be encrypted. Such encryption of data can be performed by means of well-known encryption methods, such as Rivest, Shamir and Adleman (RSA) algorithm that is the well-known public key encryption algorithm, and Data Encryption Standard (DES). These encryption methods can be specially useful for delivering charged contents to clients.

Agent A or B 21 or 22 performs a function of distributing the data, which have been divided in predetermined size and stored in server S, to respective peers to be redundantly stored therein and a function of managing the divided data stored in the respective peers to tranmit and carry in the divided data Thus, the agent always monitors that the divided data of which information are stored in which peers. Further, the agent manages the monitoring results, and when information request is issued from client C, the agent analyzes such information request based on the monitoring results and searches peers that can process the information request.

At that time, when the information request is issued from client C, the request is not delivered to server S contrary to the conventional data delivery method. The request can be delivered to Agent A or B 21 or 22. In this case, Agent A or B 21 or 22 determines which peers of Peers 1, 2, 3 and 4 11, 12, 13 and 14 have stored the requested information in the divided data format, and determine which peers of those peers can preferably deliver the divided data in accordance with prescribed rules. Selection of at least one peer suitable for delivery out of the plurality of peers can be made in accordance with the following rules.

(1) Based on analysis of a client's IP address, peers having IP addresses similar to the client's IP address can be selected. For example, if the first three (3) bytes of IP addresses of the client and the peers are similar to each other, there is much possibility that the client and the peers are positioned on the same or adjacent network(s). Thus, a high efficiency of information delivery may be expected.

(2) Based on response times of peers monitored using Ping or Trace commands, peers with good response times can be selected. If response times are short, it can be considered that network load to the peers is not heavy. Thus, a high efficiency of information delivery may be expected.

(3) Based on load of inputs/outputs and CPUs of peers measured by using an exclusive application installed in the peers, peers of which the load of the inputs/outputs and CPUs is small can be selected. If the load of the inputs/outputs and CPUs of the peers is small, such peers can process delivery works more rapidly. Thus, a high efficiency of information delivery may be expected.

(4) Service histories of peers having serviced a client can be examined to select peers.

On the basis of a portion or all of the aforementioned rules, Agent A or B 21 or 22, or the client C selects peers with desirable delivery efficiencies. Here, the server S can also be selected as one of the peers in accordance with the rules. The selected peers deliver the divided data stored in the peers themselves to client C. According to an embodiment of the present invention, if problems occur on the delivery network during delivery of the divided data from respective peers, the exclusive application executed in the client can operate to detect such problems by means of a predetermined elapse of “time-out” and the like and to inform Agent A or B 21 or 22 of the detection result. In this case, the agent can operate to select other peers, which are suitable for delivery and have the divided data, and to allow the selected peers to deliver the divided data, which have not yet been delivered due to the network problems, to client C. When delivery of all the divided data is completed, client C restores the divided data, which have been received, to the original information (decryption may also be performed according to whether the data have been encrypted) and can utilize the information for its use.

A parallel information delivery system on a network according to a preferred embodiment of the present invention may further comprise a cache manager for managing caching of the divided data of the predetermined size to be delivered between the peers. The cache manager caches data to be frequently delivered between the respective peers and then directly delivers these data to adjacent clients when the clients request the data, so that load of the network can be reduced. The cache manager may exist in the form of an independent server, or may exist in each peer in such a manner that whenever any change of cache occurs, it informs the agent of the change, in accordance with its implementation.

In such a way, since a unit of information is divided into data of a predetermined size, the divided data are stored in respective Peers 1, 2, 3 and 4 11, 12, 13 and 14, and respective Peers 1, 2, 3 and 4 11, 12, 13 and 14 deliver the divided data to client C when client C requests the information, the client receives the information in parallel from a plurality of computers (peers). If the requested information has been divided into N pieces, client C may receive the information in parallel from the maximum N peers. In a preferred embodiment according to the present invention, however, in consideration of characteristics of the information or the client, it is possible to include a function of limiting the number of pieces of the information simultaneously delivered to a predetermined number or less.

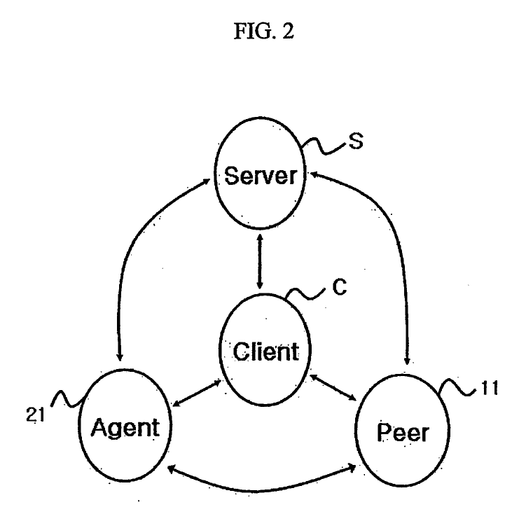

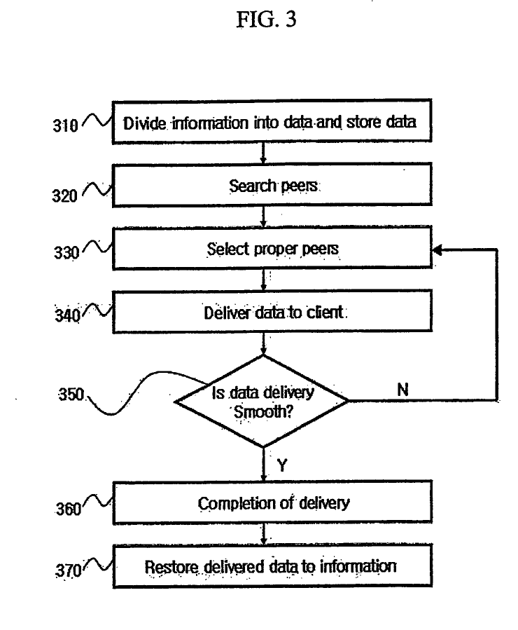

FIG. 2 is a diagram showing mutual relationships among server S, client C, agent 21 and the peer 11 that are actual elements in a field associated with the present invention, and respective elements operate through any network connected therewith in accordance with the procedures in the flowchart illustrated in FIG. 3 for the entire operation.

FIG. 3 shows the flow of the parallel information delivery on a network according to a preferred embodiment of the present invention.

At step 310, server S divides all information to be serviced into data of variable or a fixed size(s) and stores the divided data At least one agent 21 shown in FIG. 2 performs a function of redundantly distributing the divided data stored in server S to respective peers 11 and a function of managing the divided data stored in respective peers 11 to delete the divided data and carry in new data and thus the agent always monitors that which peers store the divided data of which information. Further, the agent checks information uploaded to or deleted from server S, deletes the data stored in respective peers 11 corresponding to the information deleted from server S, and redundantly distributes divided data corresponding to information newly uploaded to the server among respective peers 11.

At step 320, the agent manages the monitoring results, and when an information request is issued from client C, the agent analyzes the information request and determines which peers can process the request.

At step 330, when there is the information request issued from client C, the request is not transmitted to server S contrary to the conventional data delivery method. It can be transmitted to at least one agent 21. In this case, at least one agent 21 searches peers in which the requested information has been stored in the divided data format and informs client C of the searched peers. Client C determines which peers of those peers can preferably deliver the divided data in accordance with prescribed rules, and selects proper peers. As described above, since the divided data are redundantly stored in peers according to the present invention, one or more peers having the same data exist in the networks. Step 330 is the step of selecting peers determined as having most excellent delivery efficiency out of the one or more peers in accordance with the aforementioned rules. According to another embodiment of the present invention, although the selection of the proper peers can be made by client C, the agent operates to select the proper peers and inform client C of the selected peers. Furthermore, as described above, server S may be selected as one of the peers in accordance with the rules.

At step 340, the peers selected in step 330 deliver the divided data stored therein to the client. Conceptually, if information requested by the client is divided into N pieces, the information may be received through parallel delivery from the maximum N peers. Alternatively, in consideration of characteristics of information or client, it is possible to include a function of limiting the number of information pieces to be simultaneously delivered to a predetermined number or less.

At step 350, when obstacles occur in the network between any one of the peers and the client or unexpected situations (such as shutdown of a peer computer) occur during delivery in step 340, delivery of the divided data to be being performed by the peer can be made slow or interrupted. In this case, the exclusive application executed in the client determines whether “time-out” conditions are established after an elapse of a predetermined period of time, and notifies the agent of the fact that a delivery rate from the peer becomes lower than a predetermined rate or the delivery is interrupted. When this notice issues, the flow returns to step 330 and the above flow is repeated. In such unexpected situations, although the client may notify the agent of the fact, the agent that is monitoring the delivery situation may recognize it so that the flow can return to step 330.

At step 360, when all the divided data from the peers are delivered, the delivery is completed.

At step 370, the divided data, which have been completely delivered, are restored on the client side. In this case, the data encrypted by using a specific encryption algorithm may be decrypted and restored in a predetermined form suitable for a desired service to be provided.

Industrial Applicability

As described in detail above, according to the present invention, since the server divides the information to be serviced into a plurality of data of a predetermined size and stores the divided data in a plurality of general user computers, it is possible to exclude likelihood that the information is flown out to external computers other than a server controlled by contents providers and is used without permission of the contents providers.

Further, according to the present invention, since information is delivered not through one-to-one delivery between the server and the client but through parallel delivery among a plurality of peers and the client, time required for delivering data of the same size can be remarkably reduced. In addition, since the central server does not centrally control all requests from all clients but the plurality of peers simultaneously process the requests in parallel, load of the server can be greatly reduced, so that the cost for constructing the server can be reduced.

Moreover, if the server processes all requests in the same manner as conventional methods, the number of requests that can be simultaneously processed should be limited to a predetermined level depending on performance of the server. However, since requests from clients are distributed and then processed in the present invention, limitation on the number of requests that can be simultaneously processed can be overcome.

The preferred embodiment of the present invention described in detail above is only for illustrative purpose. It will be apparent that those skilled in the art can make various changes, modifications and additions within the technical spirit and scope of the present invention Therefore, the scope of the present invention is defined by the appended claims. The changes, modifications and additions are considered to be fallen within the scope of the present invention or are considered as equivalents of the present invention. Specifically, the aforementioned elements such as the server, agent, peers and clients are classified only in view of their functions and the physical locations thereof are irrelevant to the functional classification.

1. A method of delivering information in parallel on a network, comprising the steps of:
(a) dividing information into data of a predetermined size and storing the data;
(b) searching peers capable of providing the data of the predetermined size;
(c) selecting at least one peer out of the searched peers in accordance with prescribed rules;
(d) receiving the data of the predetermined size in parallel from the selected peer; and
(e) restoring the received data of the predetermined size to the information.

2. The method as claimed in claim 1, wherein step (a) further comprises the steps of:
encrypting the divided data; and
controlling the data of the predetermined size to be distributed to and to be redundantly stored in a server and the peers.

3. The method as claimed in claim 1, wherein the prescribed rules in step (c) includes at least one of work load of the peers themselves, a state of the network, geographical locations of the peers and past service histories of the peers.

4. The method as claimed in claim 1, wherein step (d) further comprises the step of selecting new peers and receiving again the data of the predetermined size from the newly selected peers if problems occur on the delivery network or the data are delivered at a rate lower than a predetermined rate during delivery of the data.

5. The method as claimed in claim 1, wherein step (d) further comprises the step of limiting the number of peers capable of delivering the data of the predetermined size in parallel and simultaneously to the number of the data or less.

6. A system for delivering information in parallel on a network, comprising:
a client for requesting information;
a server for dividing the information into data of a predetermined size and storing the divided data of the predetermined size;
a plurality of peers for storing the divided data of the predetermined size; and
at least one agent for managing the data of the predetermined size and/or information on the data stored in the peers and selecting peers suitable for delivering the information out of the plurality of peers in accordance with prescribed rules by analyzing the request of information delivery from the client.

7. A system for delivering information in parallel on a network, comprising:
a server for dividing the information into data of a predetermined size and storing the divided data of the predetermined size;
a plurality of peers for storing the divided data of the predetermined size; and
at least one agent for managing the data of the predetermined size and/or information on the data stored in the peers and searching peers, which have stored the divided data corresponding to the information therein, by analyzing the request of information delivery from a client; and
a client for requesting information and selecting peers suitable for delivering the information out of the searched peers in accordance with prescribed rules.

8. The system as claimed in claim 6, wherein the prescribed rules includes at least one of work load of the peers themselves, a state of the network, geographical locations of the peers and past service histories of the peers.

9. The system as claimed in claim 6, further comprising a cache manager for managing caching of the data of the predetermined size delivered between the peers.

10. The system as claimed in claim 6, wherein the server is included in the plurality of peers searched by the agent.

11. The system as claimed in claim 7, wherein the prescribed rules includes at least one of work load of the peers themselves, a state of the network, geographical locations of the peers and past service histories of the peers.

12. The system as claimed in claim 7, further comprising a cache manager for managing caching of the data of the predetermined size delivered between the peers.

13. The system as claimed in claim 7, wherein the server is included in the plurality of peers searched by the agent.
